(19) United States
(12) Patent Application Publication
(10) Pub. No.: US 2003/0009935 A1
(43) Pub. Date: Jan. 16, 2003

(54) Pane provided with a coating which prevents deposits and/or damage, and a process and device for its production

(76) Inventor: Antonius Aloysius Maria Weterings, Gravenzande (NL)

Correspondence Address: Michaelson & Wallace, Parkway 109 Office Center, 328 Newman Springs Road, PO Box 8489, Red Bank, NJ, 07701, US

(21) Appl. No.: 10/203,322

(22) PCT Filed: Feb. 12, 2001
(86) PCT No.: PCT/NL01/00113

(30) Foreign Application Priority Data
Feb. 11, 2000 (NL) 1014360

(51) Int. Cl. A01G 9/00

(52) U.S. Cl. 47/17

(57) ABSTRACT

Greenhouse provided with glass panes, at least the inner side of the said panes being provided with a coating which prevents deposits on and/or damage to the said pane. To prevent condensation which forms against the pane from forming drops, it is proposed for the coating to be of hydrophilic design. A process which allows this to be achieved is based on ordinary glass which is provided with a coating which prevents deposits on and/or damage to the said pane and involves subjecting this coating to an etching treatment. Panes can be entered in the treatment assembly where several stations are provided to apply both the coating preventing deposits and or damage and to realise the etching treatment.

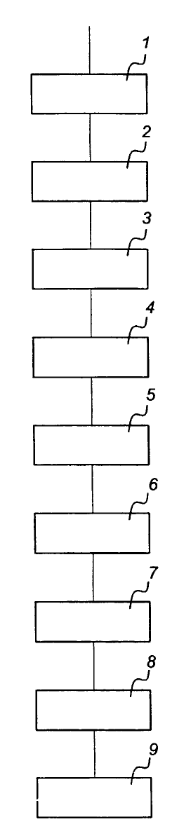

The present invention relates to a greenhouse, comprising a frame structure wherein glass panes are arranged which separate the interior of the greenhouse from the environment, at least one of the said panes being provided on at least the inner side with a coating which prevents deposits on and/or damage to the said pane.

In horticulture, there is an increasing appreciation that the amount of light in a greenhouse is of paramount importance for the productivity of the plants which are being cultivated in the greenhouse. Each percentage increase in the amount of light in the greenhouse is now considered to be of particular importance. To this end, it is possible to use particular types of glass. However, it has been found that after panes have been installed in greenhouses, the incidence of light is reduced as a result of soiling and/or damage to both the inner side and the outer side of the greenhouse. On the outer side, adverse effects of this nature can be eliminated relatively easily, since the outer side of a greenhouse is readily accessible for cleaning. In particular, special installations have been developed which move along the outer side of the greenhouse and clean it.

In U.S. Pat. No. 4,292,773A a pane is described, being assembled from one or two panels. The portion directed to the interior of the greenhouse comprises a plastic material being treated to realise less hydrofobic properties.

In practise such a plastic material is not acceptable because of the poor light transmitting properties, whilst furthermore at later cleaning the problem of damages occurs. Internal cleaning is of essential importance to guarantee sufficient introduction of light. Because of the presence of crops at the innerside of the greenhouse this can give rise to a problem.

If these crops are replaced at regular intervals, the problem can still be solved, but if the plants are only replaced, for example annually, or even at longer intervals, problems arise.

The object of the present invention is to provide a greenhouse wherein the gentle decrease in light efficiency can be reduced considerably without laborious cleaning on the inner side of the panes in the greenhouse being required.

With a greenhouse as described above, this object is achieved in that this coating is realised such that the angle of contact of a water droplet and between the inner surface of the pane is between 25° and 60° and more particular between 30° and 60°. The angle of contact is defined as being the angle between the glass surface and the generatrix to the droplet on the position of its contact with the glass surface.

In the prior art, various types of coatings are known which can be applied to (glass) panes in order to as far as possible prevent them from being damaged and to prevent deposits from being formed. In the most simple embodiment, coatings of this type are based on silanes (cf. EP-A-0476452). Coatings of this type have a extremely hydrophobic character. Very hydrofobic means in this application a glass material of which the angle of contact of a droplet and the glass has a value of about 90° or higher. Non treated glass being used in greenhouse structures has an angle of contact of about 25°. This means that condensation which inevitably precipitates on panes collects to form droplets. This is unacceptable in greenhouses, because on the one hand it leads to undesirable irrigation and on the other hand the light transmission properties of glass covered with water decrease considerably. Therefore coatings of this nature have never been successfully employed on the inside of greenhouses. On account of the measures according to the invention, the coating on the inner side is less hydrofobic. This prevents droplets from being formed, with all the attendant advantages. More particular the angle of contact is between 40° and 50°.

It will be understood that a hydrophilic layer of this nature can be obtained in any conceivable way. One possibility is, starting from a coating which is known in the prior art, for example based on silanes or titanium doixide, to carry out incipient etching of this layer. Etching can be carried out using any agent which is known in the priort art. However, it has been found that hydrogen fluoride and Chlorix give particularly good results.

In this context, the term less hydrophobic is preferably understood as meaning a surface in which the contact angle between a water drop and the said surface is at most 60° and more particularly is approximately 40°-50°.

Surprisingly, it has been found that after an etching treatment of this type the layer remains functional, i.e. the etching treatment does not remove the layer, but rather merely changes its performance. Long-term tests have shown that deposits on or damage to panes are reduced significantly further while the light efficiency remains at a constant high level.

Since condensation is unimportant or is of little importance on the outer side of the greenhouse, a customary hydrophobic layer can be arranged on the outside, in order to ensure light-transmitting properties even for a prolonged period.

Tests have shown that if a glass pane is coated on two sides with a coating based on silanes and a coating of this nature is etched on the inner side in order to impart less hydrofobic properties thereto, compared to an untreated glass pane the total light efficiency and more particularly the light efficiency in the region of the photosynthesis, is improved by at least 5% after a period of about 6 year.

Consequently, the additional price of a coating of this nature can be recovered in a relatively short time, while the time-consuming operation of cleaning panes is dispensed with to a considerable extent or altogether.

The glass material obtained by means of the process according to the invention can also be employed in other fields. One example is that of avoiding condensation on mirrors.

The invention also relates to a method for treating a glass pane. At least on the related side a hydrofobic layer is applied and this is subsequently made less hydrofobic by etching.

Furthermore the invention relates to a device for treating of glass panes comprising a conveyor system for displacing of said glass panes from a storage for panes to be treated through a treatment device to a store for treated panes, wherein alongside said conveyor system are provided: a fixed station, a station for applying substances for provision of a hydrofobic layer, a washing station, a station for providing and etching layer to a side of said pane as well as a washing station.

Below an example will be given of a device for treating of glass panes referring to the drawing. In the drawing a block diagram has been shown. Block 1 is for removal of (preferable new) glass panes from a stack and positioning in a conveyor system. This conveyor system is embodied such that the panes (which could be double walled) are engaged at their opposed sides along a very small edge and supported from below. This engagement edge is as large as or smaller than the size of the rod in for example a greenhouse so that non treatment of this edge does not result in any effect.

Subsequently the pane is cleaned. This is shown in block 2. Cleaning is depended from the condition wherein the panes are received. Intensive cleaning can be obtained with water having a low surface tension i.e. a low conductivity.

Subsequently remaining water is possibly mechanically removed and/or evaporated by drying. This is shown in block 3. After that on at least one side, i.e. the side to be treated later according to the invention, a hydrofobic layer is provided. This is shown in block 4. Such a layer can be provided by spraying or atomising. Only a small amount of liquid is necessary to that end. If appropriate, further distribution over the surface can be realized after spraying. The related chemical reaction is realised in furnace 5. As example a treatment at 60° C. during two minutes is mentioned. Gasses released can be discharged. After that cleaning is realised such as by washing which is shown by block 6. Because it is only desired to treat a side of the pane according to the invention, in step 7 a cover is provided such that during later application of the etching liquid, this liquid can not be present to the other side of the pane. In step 8 etching, for example this hydrogen fluoride is realised. Step 9 shows subsequent washing and drying.

The starting point used was a pane which had been treated with silanes using the process proposed by Chemetall and known by the name “Crystal Guard”. In one step (step 8) this glass was exposed to a hydrogen fluoride solution. After hydrogen fluoride solution had been applied using a high-pressure nozzle, after 0.5-1 minutes at room temperature the material was removed from the Crystal Guard coating.

The treatment with the HF solution comprised contacting the pane with a 2% solution HF (maximum). Applying of the HF solution can be realised with spraying techniques, brush techniques and other techniques wherein it is of importance that there is a continuous contact between HF and the glass material.

The layer which was obtained in the above way was found during measurements to have a mean contact angle of approximately 45° when water droplets were applied to it, compared with a reference layer which had a mean contact angle of approximately 90°, i.e. a layer consisting of Crystal Guard which had not been subjected to an etching treatment.

The above-described coating is preferably applied to glass. In principle, it is possible to use any type of glass, such as smoked glass, but according to the invention it is preferable to use drawn pane glass.

The base layer should be applied prior to the etching treatment. This can be carried out both by the manufacturer and in a subsequent stage. The application can be carried out using conventional processes and in particular by spraying. If the treatment is used at somewhat older glass, the cleaning step should more intensive and could comprise polishing. The etching treatment described above with HF can also be realised in several steps.

Although the invention has been described above on the basis of glass treated with silanes, it can equally well be used for other coatings which are applied to (glass) panes. One alternative is the application of coatings based on titanium oxide. These too are hydrophobic in the state wherein they are applied and can be rendered hydrophilic after the treatment according to the invention. These and further changes lie within the scope of the appended claims.

1. Greenhouse, comprising a frame structure wherein glass panes are arranged which separate the interior of the greenhouse from the environment, at least one of the said panes being provided on at least the inner side with a coating which prevents deposits on and/or damage to the said pane, characterized in that the said coating is designed in such a manner that the angle of contact of a water droplet and the inner surface of the said pane is between 25° and 60°.

2. Greenhouse according to claim 1, wherein said angle of contact of a droplet and the inner surface of said pane is between 40° and 50°.

3. Greenhouse according to one of the preceding claims, wherein the outer side of the said at least one pane is provided with a coating which prevents deposits on and/or damage to the said pane.

4. Greenhouse according to claim 3, wherein the said coating arranged on the outer side of the said pane is designed in such a manner that the outer surface of the said pane is hydrophobic.

5. Greenhouse according to one of the preceding claims, when the said coating is based on silanes and/or titanium oxide.

6. Greenhouse according to one of the preceding claims wherein the said pane comprises drawn pane glass.

7. Pane to be used for a greenhouse according to one of the preceding claims.

8. Process for producing a glass pane provided on at least one side with a coating which prevents deposits on and/or damage to the said pane, characterized in that the said coating is obtained by applying a hydrofobic coating to the said pane and then subjecting it to an etching treatment in order to impart less hydrofobic properties thereto.

9. Greenhouse according to claim 8, wherein the said etching treatment comprises the use of hydrogen fluoride.

10. Greenhouse according to claim 8 or 9, wherein the said treatment is designed in such a manner that, after the said coating has been treated, the contact angle of a water droplet lying thereon is at most 60°.

11. A method according to one of the claims 8-10, comprising cleaning of a glass pane, applying of the substances to provide a hydrofobic layer, setting at elevated temperature of said layer, providing an etching substance to a side and washing thereof.

12. A method according to claim 11, wherein said pane is provided with a hydrofobic layer on both sides thereof.

13. Device for treating half a glass pane, comprising a conveyor system for displacing of said glass panes from a storage for panes to be treated through an treatment device to a storage for treated panes, wherein alongside said conveyor systems are provided: a fixed station (2), a station (4) for applying of a substance for the provision of a hydrofobic layer, a washing station (6), a station (8) for providing an etching layer to one side of said pane as well as a washing station (9).
